(19) United States
(12) Patent Application Publication
(10) Pub. No.: US 2014/0251223 A1
(43) Pub. Date: Sep. 11, 2014

(54) Animal Watering Fountain Offering Multi-Dimensional Fluid Circulation

(71) Applicant: RADIO SYSTEMS CORP., Knoxville, TN (US)

(72) Inventors: Sean Rowe, Reno, NV (US); Junzhou Huang, Guangdong Sheng (CN)

(21) Appl. No.: 13/862,857

(22) Filed: Apr. 15, 2013

Related U.S. Application Data
(60) Provisional application No. 61/773,215, filed on Mar. 6, 2013.

(51) Int. Cl. A01K 7/00

(52) U.S. Cl. CPC A01K 7/00
USPC 119/74

(57) ABSTRACT

An animal watering fountain is provided. The fountain includes a bowl for holding an aqueous drinking fluid such as water. The fountain also includes a housing residing within the bowl, with the housing having an inlet port and an outlet port. The fountain also has a reservoir over the bowl, with the reservoir being configured to hold water. The fountain also has a pump configured to receive water from the bowl through the inlet port, and then deliver the water under pressure to both a first outlet and to a second outlet. The first outlet delivers water to the reservoir, and the second outlet delivers water through the outlet port such that water circulates around the housing and back to the inlet port. At the same time, a lip delivers water from the reservoir and back into the bowl. A method for watering an animal is also provided herein.

### CROSS REFERENCE TO RELATED APPLICATIONS

This application claims the benefit of U.S. Ser. No. 13/345,261, filed 6 Jan. 2012. That application is entitled “Animal Watering Device” and published as U.S. Pat. Publ. No. 2012/0216751.

The published application claims priority to U.S. provisional application U.S. Ser. No. 61/446,532. That application was filed on 25 Feb. 2011.

This application also claims the benefit of U.S. Ser. No. 61/773,215 filed 6 Mar. 2013. That application is entitled “Animal Watering Fountain Offering Multi-Dimensional Fluid Circulation.”

Each of these applications is incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

1. Field of the Invention

The present inventive concept relates to the field of animal watering devices. More particularly, the invention relates to animal watering devices having a submersible water filter and dispensing unit to continuously circulate water around a water bowl. Further, the invention pertains to a method of watering an animal wherein the water remains in substantially constant motion.

2. Technology in the Field of the Invention

Many animals have a preference for drinking flowing water. Flowing water provides a number of advantages, including improved taste and quality. Flowing water also typically has more dissolved oxygen, which can make the water taste better as well as provide potential health benefits. One health benefit of flowing water is that it can encourage animals to drink more liquids. This, in turn, can help reduce problems with the animal's kidneys or urinary tract. In addition to these benefits, running water is interesting and entertaining to many animals.

Many household pet owners have recognized that their pets are drawn towards running water. Many dogs like to drink from hoses, streams, or water flowing along a curb. Cats often jump on counters and sinks in order to drink from a running or leaking faucet. Some pet owners even deliberately accommodate such behavior, for example, by letting a hose or faucet drip.

However, many animals do not have adequate access to a source of running water. Animals may engage in undesirable behavior in search of running water, such as jumping on counters or in bath tubs. Owners who do provide running water for their animals may incur significant expense by leaving faucets or hoses running

Pet fountains have been developed to provide running water to pets. For example, Veterinary Ventures, Inc., of Reno, Nev. offers a variety of pet fountains, such as the Drinkwell® and Drinkwell® Big Dog products. Such fountains typically include a water reservoir, an elevated spout that dispenses water, and a bowl into which the water is dispensed and from which the animal can drink. Some fountains provide a stream of free falling water, which can help stimulate animals' interest in the fountain as well as enhance water oxygenation.

One of the challenges facing known pet fountains is to provide a constant flow of fresh and clean running water. For example, some fountains can accumulate debris such as hair and food, particularly if the owner does not adequately maintain the fountain. Such debris can reduce water quality and impair water circulation in the fountain, for example, by clogging an intake or outtake of a pump. If the water circulation is sufficiently impaired, a water circulation device may be damaged. In addition, some prior fountains contain pumps having at least portions that should not be in contact with water, potentially making cleaning of the fountain more difficult.

If fountains are not properly maintained, the benefits of animal watering fountains can be reduced or even reversed. However, typical fountains often have a large number of parts that need to be removed and reassembled during routine maintenance of the fountain. For example, an upper water dispensing portion is typically removable from a lower bowl portion. Reassembling this structure can be difficult for some users. Further, the water circulation device of such fountains is often not easily accessible by the user, and thus not adequately cleaned.

In order to improve the quality of the water provided to animals drinking from the pet fountains, some prior fountains are designed to accept filters. Such filters typically contain a quantity of an impurity-absorbing material, such as activated carbon. However, such material can have a tendency to settle into the bottom portion of the filter, reducing the effectiveness of the filter, as water that circulates through other portions of the filter does not contact the absorbing material.

Embodiments of the present general inventive concept provide an easily-maintained animal watering device that provides substantially continuously-moving, filtered, drinking water for animals without components that are compromised when exposed to water.

### BRIEF SUMMARY OF THE INVENTION

An animal watering fountain is first provided herein. In one embodiment, the animal watering fountain includes a bowl. The bowl defines a wall and an interior basin for holding an aqueous drinking fluid. Preferably, the aqueous drinking fluid is water.

The watering fountain also has a housing. The housing resides within the bowl. The housing comprises an inlet port and an outlet port in fluid communication with the interior basin. In one aspect, the watering fountain is arranged so that the water circulates radially along the wall of the bowl, with the wall having a circular profile

The watering fountain further includes a reservoir. The reservoir substantially resides over the bowl. The reservoir is configured to hold a portion of the drinking fluid.

The watering fountain offers a submersible pump. The submersible pump is configured to receive the drinking fluid from the interior basin through the inlet port, and then deliver the drinking fluid under pressure to both a first outlet and to a second outlet. The first outlet is configured to deliver water to the reservoir, while the second outlet is configured to deliver water through the outlet port. In this way, water circulates around the interior basin.

It is preferred that the first outlet and the second outlet extend from a y-tube. The y-tube, in turn, has an inlet that receives water from an outlet of the submersible pump.

The watering fountain provides for filtering of the water. Thus, at least one, and preferably two, filters are provided. A first filter resides at least partially in the basin for filtering the drinking fluid as it circulates into the pump. The filter preferably resides between the inlet port and the submersible pump.

The watering foundation additionally includes a lip. The lip is dimensioned and arranged to deliver drinking fluid from the reservoir back into the interior basin of the bowl. In one aspect, the lip actually extends several inches, and even a foot. Preferably, the watering fountain includes a splash ramp for receiving water falling down from the lip.

As can be seen, the present general inventive concept provides a submersible water filter and dispensing unit arrangement for use in an animal water bowl. After the water is filtered, the dispensing unit can dispense the water back into the bowl through an aperture positioned on the bottom of the water bowl such that the water flows around the bowl. The filtered water can thus be made to flow in such a way to circulate the water around the bowl, allowing the water to remain clean, fresh, and in constant motion for the animal to drink. The circulation can also help enhance water oxygenation.

Simultaneously, a true fountain is provided. A portion of the filtered water is thieved, and transported up to a reservoir over the bowl. The water then pours over a lip and back into the bowl.

A method is also disclosed, in accordance with various embodiments of the present general inventive concept, for delivering water to an animal. The method employs the use of a fountain having constantly circulating, filtered water.

The method first includes providing a bowl. The bowl defines a wall and an interior basin for holding an aqueous drinking fluid. Preferably, the aqueous drinking fluid is water. Preferably, the wall forms a radial basin.

The method also includes disposing a housing within the bowl. The housing comprises an inlet port and an outlet port in fluid communication with the interior basin. The housing also holds a submersible pump for moving water from the inlet port to the outlet port.

The method additionally includes the step of placing a reservoir over the bowl. The reservoir is configured to hold a portion of the drinking fluid. The reservoir offers a lip that is arranged to deliver the portion of drinking fluid from the reservoir back into the interior basin of the bowl. This occurs as a level of drinking fluid rises within the reservoir.

The method further provides for placing aqueous drinking fluid into the interior basin of the bowl. The drinking fluid is further placed into the reservoir.

Then, the method includes activating the pump. The pump is activated in order to cause drinking fluid to simultaneously flow (i) through the first outlet and up to the reservoir, (ii) over the lip where the drinking fluid gravitationally falls down into the interior basin, and (iii) through the second outlet and into the interior basin, where the drinking fluid then flows around the housing and to the inlet port.

Additionally, the method includes filtering drinking fluid. This occurs as the drinking fluid flows between the inlet port and the pump. At least one filter is provided for the animal watering fountain of the method herein. In one aspect, a filter is provided in the reservoir. The filter divides the reservoir into a first compartment that receives water from the first outlet of the pump, and a second compartment that receives water that passes through the filter.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1A is a first perspective view of an animal watering fountain of the present invention, in one embodiment. The view is taken from a right side of the fountain. No water is in the basin of the fountain.

FIG. 1B is another perspective view of the animal watering fountain of FIG. 1A. Here, the view is taken from a left side of the fountain. Water is placed in the fountain and a pump is activated, creating a spout of flowing water.

FIG. 2A is a side view of the animal watering fountain of FIGS. 1A and 1B, taken from a left side of the fountain.

FIG. 2B is another side view of the animal watering fountain of FIGS. 1A and 1B, but taken from a right side of the fountain.

FIG. 3 is a perspective view of a portion of the housing from the animal watering fountain of FIGS. 1A and 1B. A cap has been removed from the housing, exposing a reservoir with a filter.

FIG. 4 is another perspective view of the animal watering fountain of FIGS. 1A and 1B. Here, the cap has again been removed from the housing. A filter has further been removed from the reservoir.

FIG. 5 is a perspective view of just the housing of the animal watering fountain of FIGS. 1A and 1B.

FIG. 6 is a top view of the animal watering fountain of FIGS. 1A and 1B, with the housing removed.

FIG. 7A is a perspective view of a submersible electrical pump and “y-tube” as may be used in the animal watering fountain of FIGS. 1A and 1B.

FIG. 7B is a perspective view of just the y-tube of FIG. 7A.

FIG. 7C is another perspective view of the y-tube of FIG. 7B. Here, a tubular extension is provided to one of the outlets.

FIG. 8 is a bottom perspective view of the housing of the animal watering fountain of FIGS. 1A and 1B. Here, the y-tube is connected to a reservoir that is integral to the housing.

FIG. 9 is a top view of the housing of the animal watering fountain of FIG. 8. The reservoir and filter are more clearly seen.

FIG. 10 is a perspective view of components for a water inlet sealing assembly, with the components shown in exploded-apart relation.

FIG. 11 is a perspective view of an end portion of an electrical cord as may be used for the animal watering fountain of FIGS. 1A and 1B. An electrical adapter is shown at an end of the cord.

### DETAILED DESCRIPTION OF CERTAIN EMBODIMENTS

### Definitions

As used herein, the term “lip” refers to any outlet surface or ledge for delivering an aqueous fluid. Water may be pumped over the lip under low pressure. Alternatively, water may simply gravitationally fall over the lip and back into the basin below. The term “lip” may also refer to the end of an outlet tube.

As used herein, the term “reservoir” refers to any bowl, basin, tubing or channel capable of holding, carrying or transporting water.

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

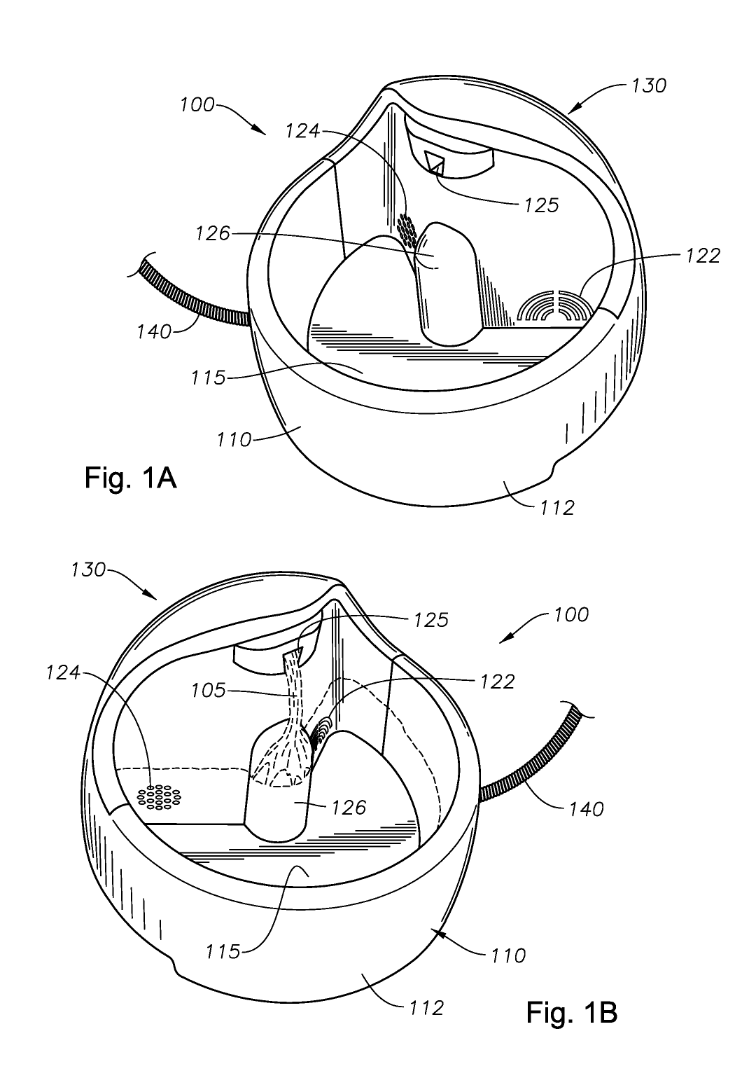

FIG. 1A is a first perspective view of an animal watering fountain 100 of the present invention, in one embodiment. The view is taken from a right side of the fountain 100.

As illustrated, the animal watering fountain 100 first has a bowl 110. The bowl 110 defines a radial wall 112 and an interior basin 115. The wall 112 and the basin 115 together hold an aqueous drinking fluid such as water. In FIG. 1A, the bowl 110 is shown without water. However, FIG. 1B is offered wherein the bowl 110 is holding water.

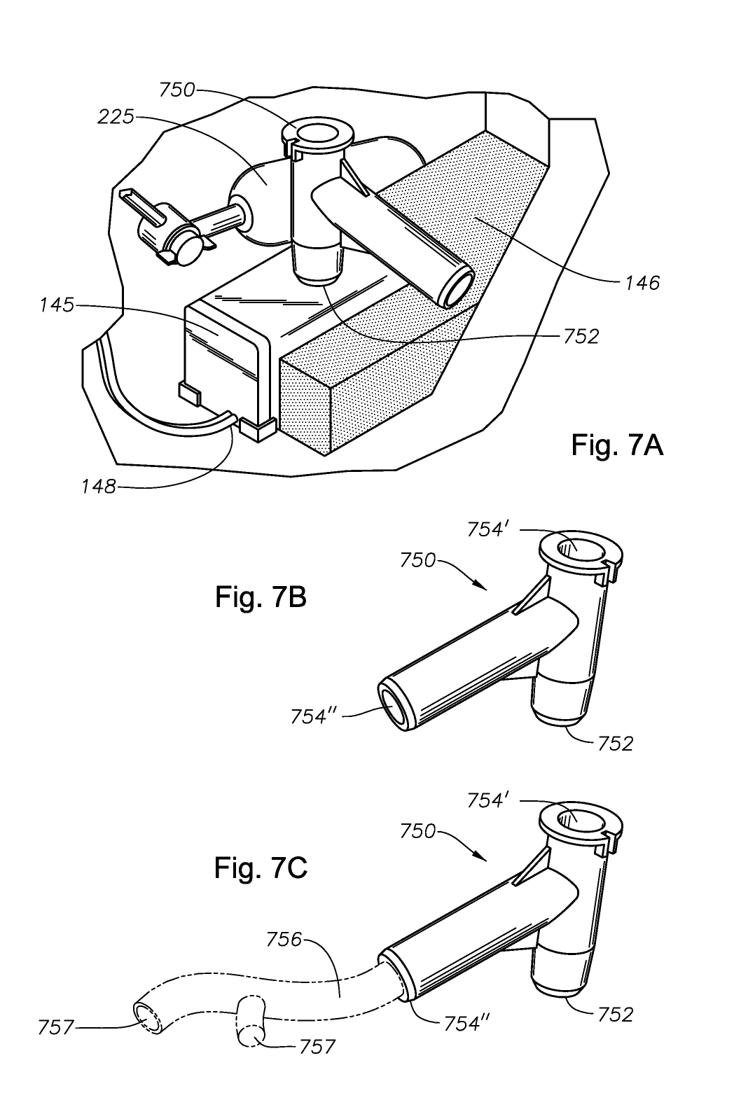

FIG. 1B offers a second perspective view of the animal watering fountain 100 of FIG. 1A. Here, the view is taken from a left side of the fountain 100. Water is placed in the bowl 110. A pump (shown in FIGS. 6 and 7A, discussed below) has been activated, creating an aesthetically pleasing spout 105 of flowing water.

The animal watering fountain 100 exists not only to hold water, but also to circulate that water so that it remains fresh and oxygenated. In addition, the water is filtered so that it is maintained in a clean or particle-free state. In order to provide the circulation and filtering functions, various components are provided. Those components are generally held within a housing 130, and are not visible in FIGS. 1A and 1B. However, the components are shown in other figures and are discussed below.

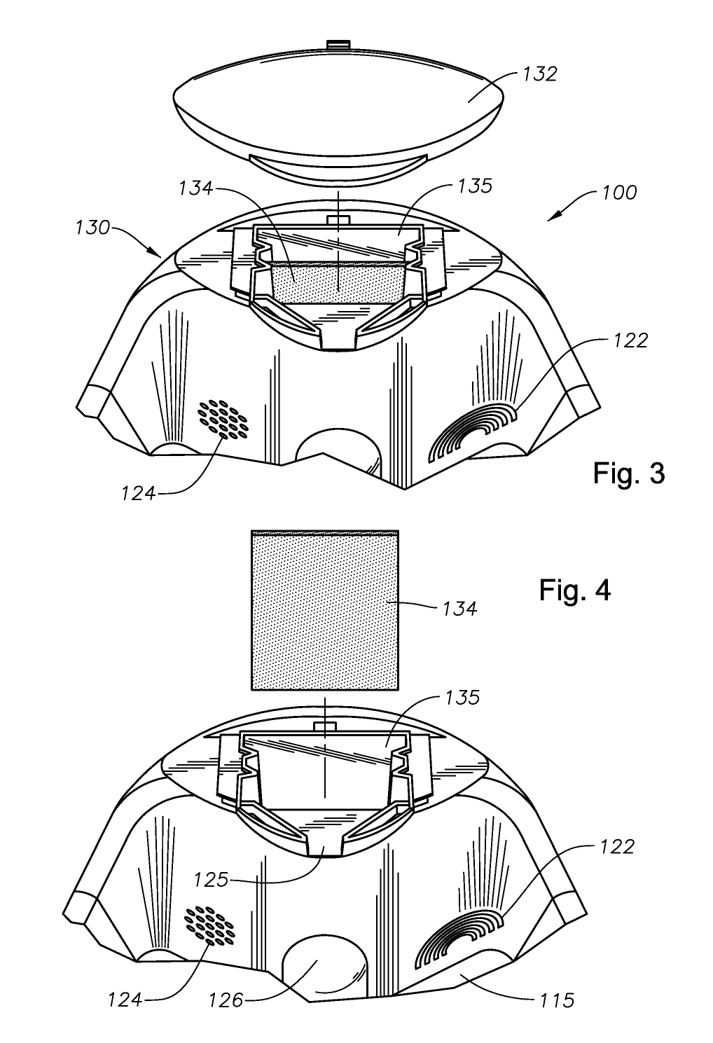

Referring to FIGS. 1A and 1B together, the watering fountain 100 includes an inlet port 122 and an outlet port 124. In the illustrative arrangement of FIGS. 1A and 1B, the inlet port 122 and the outlet port 124 are in the form of grates formed in the housing 130. Water is drawn into the housing 130 through the inlet port 122. A first portion of water is pumped back into the basin 115 through the outlet port 124, while a second portion of water is pumped into a reservoir (shown in FIGS. 3 and 4) and released through a spout opening 125. Water falls from the spout opening 125 as a spout 105, and falls back into the basin 115.

Optionally, a splash ramp 126 is provided above the water level in the basin 115. This keeps water from splattering over the wall 112 and out of the bowl 110.

The animal watering fountain 100 is designed to provide water for an animal (not shown). The animal is ideally a domesticated dog or cat. The owner fills the basin 115 with water, and then activates a pump (seen at 145 in FIGS. 6 and 7A). The pump 145 keeps water flowing through the housing 130 and back into the basin 115, and also through a reservoir (seen at 135 in FIGS. 3 and 4), through the spout opening 125, and back into the basin 115.

Preferably, the pump is a submersible pump operating at 50-60 Hz and about 5.2 volts of power. The pump may be, for example, the SP-880 aquarium pump manufactured by Resun™ of Shenzhen, China. The pump 145 may have a valve that allows the operator to adjust the water flow. In one aspect, the pump 145 pumps up to about 370 liters of fluid per hour.

It is expected that as the animal drinks from the bowl 110, the water level in the basin 115 will drop. In addition, normal evaporation will thief some water from the fountain 110. Therefore, it is preferred that an external water source be provided for the fountain 100. Such an external water source may be a typical garden hose (not shown).

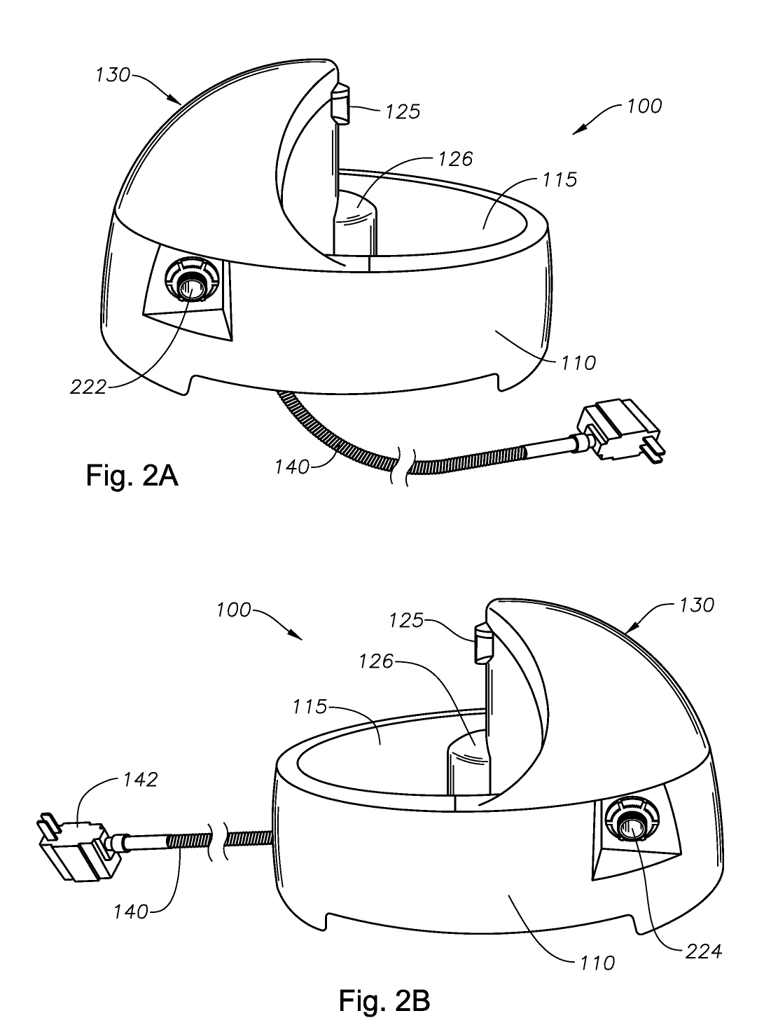

FIG. 2A is a side view of the animal watering fountain of FIGS. 1A and 1B, taken from a left side of the fountain 100. FIG. 2B is another side view of the animal watering fountain 100, but taken from a right side of the fountain 100. On each side, a water inlet is provided. On the left side, inlet 222 is seen, while on the right side inlet 224 is seen.

Each inlet 222, 224 is configured to threadedly receive the male end of a garden hose. It is understood that only one hose connection is needed and, accordingly, only one of the inlets 222, 224 is required. The fountain 100 beneficially offers two positional options to accommodate hose location.

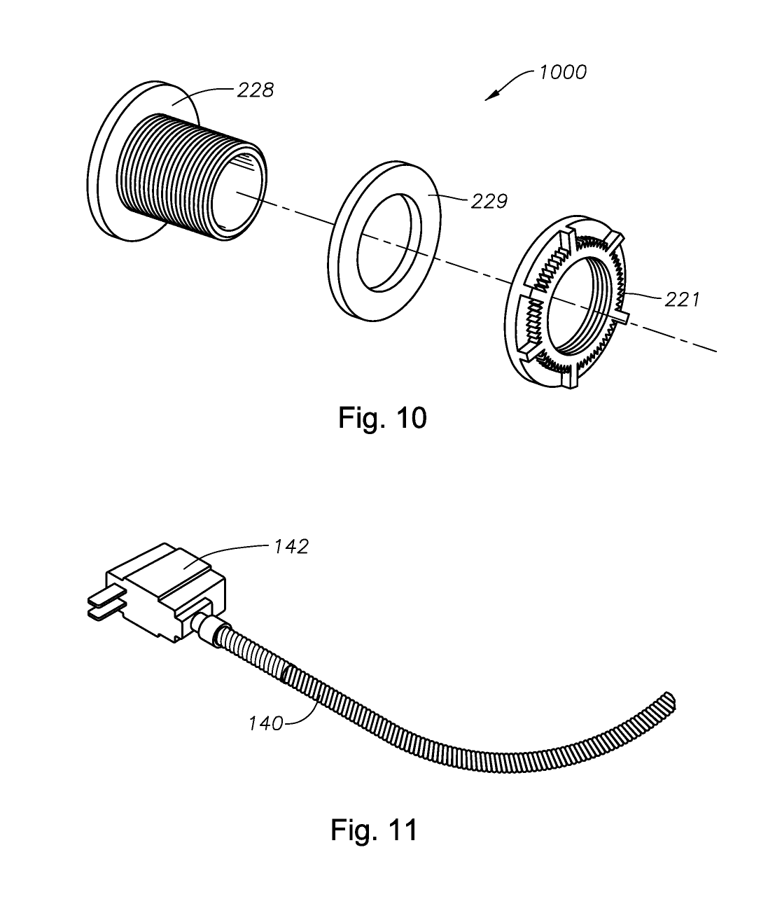

In practice, a garden hose is connected at low pressure at, for example, inlet 222. Water slowly runs from the hose and into the bowl 110. The fountain 100 is equipped with a mechanical float valve (discussed below in connection with FIG. 6) so that water is maintained at a desired level in the basin 115. In this way, water flow is shut off when the water line reaches a certain level. The other inlet, such as inlet 224, is sealed. Components of a water inlet sealing assembly 1000 are shown in FIG. 10, discussed below.

As noted above in connection with FIGS. 1A and 1B, the fountain 100 includes a housing 130. The housing 130 conceals operational components of the fountain 100, helping keep them clean and safe. FIGS. 3, 4 and 5 provide different perspective view of the housing 130.

First, FIG. 3 is a perspective view of a portion of the housing 130 from the animal watering fountain 100. Here, it can be seen that the housing 130 includes a removable cap 132. The cap 132 is shown separated from the housing 130, revealing a reservoir 135 within the housing 130. The reservoir 135 receives water from the pump 145 when the pump 145 is activated, e.g., when the electrical cord 140 is plugged in.

FIG. 3 also reveals a filter 134 residing within the reservoir 135. The filter 134 is preferably a non-absorbent charcoal filter. The filter 134 divides the reservoir 135 into two compartments. Water flows from the pump 145 into a first compartment (shown at 910 in FIG. 9) behind the filter 135. The water then flows through the filter 135 and into the second compartment (shown at 920 in FIG. 9). As water fills the second compartment, it reaches the spout opening 125 of the housing 130. The spout opening 125 thus serves as a lip over which water flows down into the basin 115.

FIG. 4 provides another perspective view of the animal watering fountain 100 of FIGS. 1A and 1B. Here, the cap 132 has been removed from the housing 130 and is not seen. In addition, the filter 135 has been removed from the housing 130. The filter 135 is shown exploded above the housing 130 for illustrative purposes.

Interestingly, FIG. 4 more clearly shows the inlet port 122 and the outlet port 124 in the housing 130. In addition, the splash ramp 126 is seen below the spout opening 125.

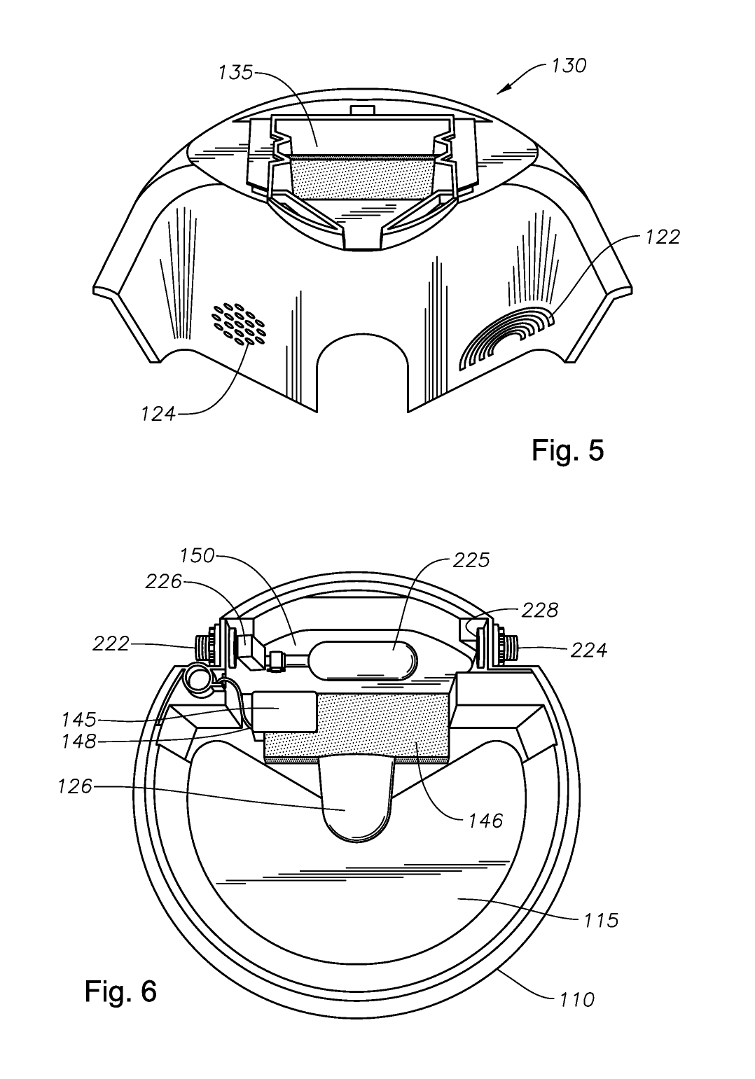

FIG. 5 offers an additional perspective view of the housing 130 of the animal watering fountain 100. It can be seen that the housing 130 is a removable component that snaps in and out of place. The housing 130 is preferably fabricated from a polycarbonate or polystyrene material. Such a plastic material offers a light-weight but durable material that is also easily cleaned by a pet owner.

Of interest, the reservoir 135 is seen in the housing 130. In this arrangement, the reservoir 135 is a single integral fluid chamber within the housing 130. However, other arrangements may be employed where multiple chambers that are removable from the housing 130 and interchangeable may be used. For example, the reservoir may comprise one or more bottles for holding water. This is beneficial for indoor purposes where a garden hose is not typically available.

Moving now to FIG. 6, FIG. 6 is a top view of the animal watering fountain 100 of FIGS. 1A and 1B. Here, the housing 130 has been removed from the bowl 110. This exposes operational components including the splash ramp 126, the pump 145, a foam filter 146, and a connecting end 148 of the electrical cord 140. It is observed that the splash ramp 126 forms an island around which water circulates within the bowl 110.

FIG. 6 also shows that the fountain 100 includes a receiving bowl 150. Water may be introduced to the interior basin 115 through the receiving bowl 150, which resides within the housing 130. An optional float valve 226 is placed within the receiving bowl 150. The float valve 226 defines a mechanically pivoting connection at the water inlet 222. The float valve 226 includes a floating bulb 225 that causes the valve 226 to shut off when the water level inside the receiving bowl 150 gets too high.

FIG. 7A is a perspective view of the submersible electrical pump 145 and a connected y-tube 750. The y-tube 750 is shown connected to an outlet 752 on top of the pump 145.

FIG. 7B is a perspective view of just the y-tube 750 of FIG. 7A. Here, it can be seen that the y-tube 750 has an inlet 752. The inlet 752 is frictionally and sealingly engaged with an outlet of the pump 145. The y-tube 750 also has a first outlet 754′. The first outlet 754′ delivers water to the reservoir 135 of the housing 130. The y-tube 750 further has second outlet 754″. The second outlet 754″ delivers water to the outlet port 124 of the housing 130.

It is understood that the y-tube 750 of FIG. 7B is merely illustrative. Other arrangements for providing a split stream of water may be employed. These may include a manifold having tubes.

FIG. 7C is another perspective view of the y-tube 750 of FIG. 7B. Here, a tubular extension 756 is provided to the second outlet 754″. The tubular extension 756 offers two or more outlets 757 for directing water within the basin 115. This further encourages a radial circulation of water in the bowl 110.

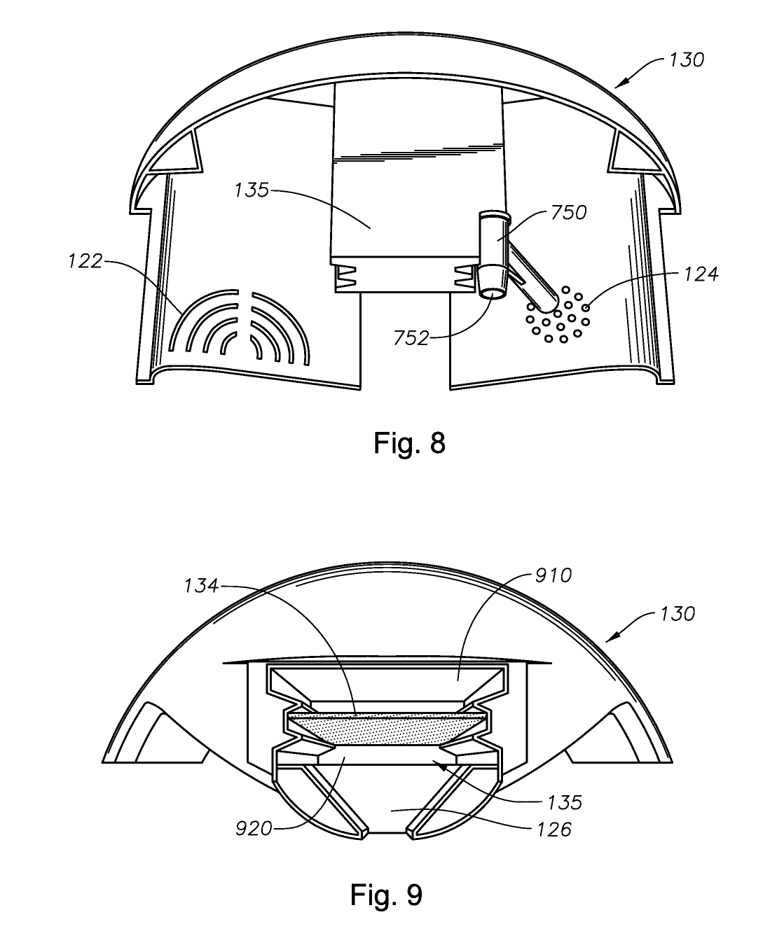

FIG. 8 and FIG. 9 offer additional perspective views of the housing 130 of the animal watering fountain 100. In FIG. 8, a rear perspective view of the housing 130 is shown. Here, the y-tube 750 is seen connected to the reservoir 135. The illustrative reservoir 135 again is integral to the housing 130.

FIG. 9 is a top view of the housing 130. The reservoir 135 and filter 134 are more clearly seen. Specifically, the filter 134 is shown dividing the reservoir 135 into a first compartment 910 and a second compartment 920. Water is delivered from the first outlet 754′ of the y-tube into the first compartment 910 of the reservoir 135. Water then flows through the charcoal filter 134 from the first compartment 910 and into the second compartment 920. As the two compartments 910, 920 fill up, water spills over the spout opening 125 and into the basin 115.

Additional features of the animal watering device 100 are offered in FIGS. 10 and 11. FIG. 10 provides a perspective view of components for a water inlet sealing assembly 1000. The assembly 1000 sealingly fits within a water inlet 222 and/or 224 that is to be sealed. In FIG. 10, the illustrative components include a threaded sealing cap 1010, an o-ring 1020, and a threaded locking member 1030. These components 1010, 1020, 1030 are shown in exploded-apart relation.

FIG. 11 is a perspective view of an electrical cord 140 as may be used for the animal watering fountain 100 of FIGS. 1A and 1B. Preferably, the cord 140 has a bite-resistant outer cover that keeps a puppy (or other animal) from being shocked should the animal bite through the cord 140. A low-voltage power adapter 142 is provided at a distal end of the cord 140.

As can be seen, a novel animal watering device is offered herein. The watering device presented in the figures discussed above is just one embodiment of the invention claimed herein. Other embodiments may be employed without departing from the broader scope and spirit of the present general inventive concept. For example, an agitator can be used to dispense water in a selected direction out of the outlet port 124. In some embodiments, the pump may be powered through solar power or via a battery. In one embodiment, an impeller is placed along the interior basin 115 for urging water to flow from the outlet port 124, around the basin 115, and to the inlet port 124. A drive motor may be employed for mechanically imparting rotational movement to a shaft of the impeller.

In practice, water is added to the watering bowl 110 such that water becomes pooled inside the basin 115 of the watering bowl 110. In addition, the receiving bowl 150 receives water as part of the watering bowl 110. Water level may be maintained through the use of the float valve 126 in the receiving bowl. Water may further be added to the reservoir 135. The pump 145 is powered to pump water and dispense the water from the basin 115 through the inlet port 122. Stated another way, water is drawn from the water bowl 110 into the housing 130 through the inlet port 122. After the water permeates through the pre-filter 146, the pump 145 can re-dispense the water back into the basin 115 through the outlet port 124. At the same time, water is pumped to the reservoir 135 and the spout opening 125 over the basin 110. The watering fountain 100 uses the y-tube 750 as a splitter.

During pumping, water is generally filtered by the foam pre-filter 146. In addition, water is filtered by the charcoal filter 134 residing within the reservoir 135. Optionally, the basin 115 includes a sloped bottom to encourage movement of the water. Optionally, the pump 145 dispenses water through a tube such as tube 756 having two or more openings 757 positioned adjacent to the bottom surface of the water bowl 110 parallel with the sides 112 of the bowl 110. In this way, the water is continually circulated around the basin 115, allowing the water to remain in constant motion. Water re-enters the housing 130 at the inlet port 124 where it is re-filtered, thus providing a constant flow of clean, filtered water for the animal to drink.

In view of the present disclosure, it is evident that embodiments of the present general inventive concept can provide animal watering devices having a number of advantages. For instance, the example embodiments can be easy to clean and maintain, such as by having parts which are easily removed or replaced. Indeed, certain embodiments include an easily removable debris filter, which may be a pre-filter that helps trap debris before water passes to the dispensing unit, additional filters, or both. It is possible to construct the detachable portions to include convenient slide-in or snap-on parts that can be easily removed, but which are secured against a base unit to prevent accidental removal by a pet.

A method of delivering water to an animal is also provided herein. The method generally includes providing a bowl. The bowl defines a wall and an interior basin for holding an aqueous drinking fluid such as water. The method also includes disposing a housing within the bowl. The housing comprises an inlet port and an outlet port. The two ports are in fluid communication with the interior basin. The housing also holds a pump for moving water from the inlet port to the outlet port and, optionally, a pre-filter for filtering water as it moves from the inlet port into the pump.

The method also includes placing a reservoir over the bowl. The reservoir is preferably integral to the housing. The reservoir is configured to hold a portion of the drinking fluid. The reservoir and associated housing offer a lip that is arranged to deliver drinking fluid from the reservoir back into the interior basin of the bowl. This occurs as spill-over as a level of drinking fluid rises within the reservoir.

The method further includes placing aqueous drinking fluid into the interior basin of the bowl. Drinking fluid may further be placed directly into the reservoir. From there, the method includes activating the pump in order to cause drinking fluid to simultaneously flow (i) through the first outlet and up to the reservoir, (ii) over the lip where the drinking fluid gravitationally falls down into the interior basin, and (iii) through the second outlet and into the interior basin. The drinking fluid then flows around the housing and back to the inlet port in circular fashion.

Variations of the method for watering an animal may fall within the spirit of the claims, below. It will be appreciated that the inventions are susceptible to modification, variation and change without departing from the spirit thereof.

We claim:

1. An animal watering fountain, comprising:
a bowl defining a wall and an interior basin for holding an aqueous drinking fluid;
a housing residing within the bowl, the housing comprising an inlet port and an outlet port in fluid communication with the interior basin;
a reservoir extending over the bowl, the reservoir configured to hold a portion of the drinking fluid;
a submersible pump configured to receive the drinking fluid from the interior basin through the inlet port, and deliver the drinking fluid under pressure to both a first outlet and to a second outlet, wherein the first outlet is configured to deliver water to the reservoir, and the second outlet is configured to deliver water through the outlet port such that water circulates around the interior basin;
a first filter residing at least partially in the basin for pre-filtering the drinking fluid as it circulates into the pump; and
a lip dimensioned and arranged to deliver drinking fluid from the reservoir back into the interior basin of the bowl.

2. The animal watering fountain of claim 1, wherein the aqueous drinking fluid comprises substantially water.

3. The animal watering fountain of claim 2, wherein the first filter resides between the inlet port and the submersible pump.

4. The animal watering fountain of claim 2, wherein:
the wall of the bowl has a circular profile; and
circulation of the water is in a generally radial flow path from the outlet port to the inlet port.

5. The animal watering fountain of claim 4, wherein the lip is configured to deliver water onto a splash ramp in the basin.

6. The animal watering fountain of claim 4, wherein:
the housing further comprises a neck portion extending to the wall of the bowl, with the neck portion having opposing sides to define the inlet port and the outlet port, respectively.

7. The animal watering fountain of claim 2, wherein the housing comprises:
a detachable cover that substantially covers the submersible pump;
a first grated wing that serves as the inlet port; and
a second grated wing that serves as the outlet port.

8. The animal watering fountain of claim 4, wherein the interior basin of the bowl comprises a bottom surface that is sloped downward from the outlet port to encourage the flow of water around the splash ramp and to the inlet port.

9. The animal watering fountain of claim 4, further comprising:
an impeller placed along the interior basin of the bowl for urging water to flow from the outlet port, around the island, and to the inlet port; and
a drive motor for mechanically imparting rotational movement to a shaft of the impeller.

10. The animal watering fountain of claim 4, further comprising:
a receiving bowl in fluid communication with the interior basin;
a water inlet configured to deliver water from an external hose into the receiving bow; and
a float valve that maintains a level of the water in the receiving bowl.

11. The animal watering fountain of claim 4, wherein the second outlet comprises an elongated tube having at least two openings spaced apart along a length of the tube.

12. The animal watering fountain of claim 2, wherein the first outlet and the second outlet extend from a y-tube in fluid communication with the submersible pump.

13. The animal watering fountain of claim 2, further comprising:
a second filter placed within the reservoir, the filter dividing the reservoir into a first compartment that receives water from the first outlet of the pump, and a second compartment that receives water that passes through the filter.

14. A method of delivering water to animals, comprising:
providing a bowl, the bowl defining a wall and an interior basin for holding an aqueous drinking fluid;
disposing a housing within the bowl, the housing comprising an inlet port and an outlet port in fluid communication with the interior basin, and a pump for moving water from the inlet port to the outlet port;
placing a reservoir over the bowl, the reservoir being configured to hold a portion of the drinking fluid, and a lip arranged to deliver drinking fluid from the reservoir back into the interior basin of the bowl;
placing aqueous drinking fluid into the interior basin of the bowl;
activating the pump in order to cause drinking fluid to simultaneously flow (i) through the first outlet and up to the reservoir, (ii) over the lip where the drinking fluid gravitationally falls down into the interior basin, and (iii) through the second outlet and into the interior basin, where the drinking fluid then flows around the housing and to the inlet port; and
filtering drinking fluid as the drinking fluid flows between the inlet port and the pump.

16. The method of claim 15, wherein the aqueous drinking fluid comprises substantially water.

17. The method of claim 16, wherein the housing further comprises a filter placed within the reservoir, the filter dividing the reservoir into a first compartment that receives water from the first outlet of the pump, and a second compartment that receives water that passes through the filter.

18. The method of claim 16, wherein:
the wall of the bowl has a circular profile; and
circulation of the water is in a generally radial flow path from the outlet port to the inlet port.

19. The method of claim 18, wherein the lip is arranged to deliver water onto the splash ramp.

20. The method of claim 19, wherein water flows over the lip as a level of water rises within the reservoir.

21. The method of claim 16, further comprising:
pouring water into the reservoir prior to activating the pump.

22. The method of claim 16, further comprising:
attaching an external hose to a water inlet along the wall, thereby placing the external hose in fluid communication with the interior basin.

23. The method of claim 22, wherein the bowl further defines a float valve that maintains a level of the water in the interior basin by closing off the water inlet when the water level rises to a predetermined line.

24. The method of claim 16, wherein the first outlet and the second outlet extend from a y-tube in fluid communication with the submersible pump.
